(19) United States
(12) Patent Application Publication
(10) Pub. No.: US 2023/0373268 A1
(43) Pub. Date: Nov. 23, 2023

(54) REAR GLASS DEFROSTER AND DEFROSTER SYSTEM AND METHOD FOR CONTROLLING THE SAME

(71) Applicant: GM Global Technology Operations LLC, Detroit, MI (US)

(72) Inventor: Vipul M. Patel, Northville, MI (US)

(73) Assignee: GM GLOBAL TECHNOLOGY OPERATIONS LLC, Detroit, MI (US)

(21) Appl. No.: 17/748,342

(22) Filed: May 19, 2022

(51) Int. Cl. B60H 1/00

(52) U.S. Cl. CPC B60H 1/00785; B60H 1/00878; H05B 3/84

(57) ABSTRACT

A method for controlling a rear glass defroster for a vehicle upon start-up is presented. First, one or more factors are determined, which are selected from a temperature of an environment immediately outside the vehicle, a humidity of the environment, a dew point of the environment, a barometric pressure of the environment, a temperature of a rear glass of the vehicle, a temperature of an internal cabin of the vehicle and a sun load on the vehicle. Next, the one or more factors are compared to one or more corresponding predetermined thresholds or ranges that are indicative of conditions suitable for frost formation on a rear glass of the vehicle. Then, if the comparison indicates that the one or more factors meet the frost formation conditions, the rear glass defroster is activated. A vehicle rear-glass defrost system which uses the foregoing method is also presented.

### INTRODUCTION

This disclosure relates generally to rear glass defrosters and rear glass defroster systems for automotive vehicles and methods for controlling such defrosters and systems.

In electric vehicles, it is common for the rear glass defroster to be automatically activated upon vehicle start-up. This is done to defrost or melt any ice or frost which may have formed on the rear glass of the vehicle. For example, if the vehicle has been left outside or in a cold garage overnight and then started in the morning, it is possible that frost may have formed on the rear glass due to cold temperatures that the vehicle has been exposed to.

While the automatic activation of the rear defroster may be seen as a useful convenience, especially in cooler seasons or climates, it may also be viewed as an unnecessary use of battery power in instances where no ice or frost has actually been formed on the rear glass. This may be a concern for any type of vehicle, but it may be a particular concern for electric vehicles which rely on the use of the vehicle's battery power.

### SUMMARY

According to one embodiment, a method for controlling a rear glass defroster for a vehicle upon start-up includes: (i) determining one or more factors selected from a temperature of an environment immediately outside the vehicle, a humidity of the environment, a dew point of the environment, a barometric pressure of the environment, a temperature of a rear glass of the vehicle, a temperature of an internal cabin of the vehicle and a sun load on the vehicle; (ii) comparing the one or more factors to one or more corresponding predetermined thresholds or ranges that are indicative of conditions suitable for frost formation on a rear glass of the vehicle; and (iii) if the comparison indicates that the one or more factors meet the frost formation conditions, then activating the rear glass defroster.

The method may further include detecting a commanded start of the vehicle. The detecting step may be performed before the determining, comparing and activating steps. The method may further include proceeding to the determining, comparing and activating steps if the commanded start is detected.

Additionally, the method may further include establishing a location of the vehicle. Here, at least one of the establishing, determining and comparing steps may be performed by a remote service that is in communication with the vehicle, with at least one of location-related information, factor-related information and comparison-related information being communicated between the vehicle and the remote service. The remote service and the vehicle may communicate with each other via one or more of a cellular signal, a satellite signal, a Wi-Fi signal, a Bluetooth signal, a radio signal and an internet signal. Alternatively, at least one of the establishing, determining and comparing steps may be performed by a controller on-board the vehicle.

The method may also include setting a flag in a memory (if the comparison indicates that the one or more factors meet the frost formation conditions), detecting a commanded start of the vehicle, and activating the rear glass defroster (if the flag is set and a commanded start of the vehicle is detected).

According to another embodiment, a method is proposed for controlling a rear glass defroster system for a vehicle upon start-up, wherein the system includes a rear glass, a rear glass defroster, one or more sensors, and a controller operatively connected with the defroster and the one or more sensors. The method includes: (i) determining, using the one or more sensors and/or a remote service that is in communication with the vehicle, one or more factors selected from a temperature of an environment immediately outside the vehicle, a humidity of the environment, a dew point of the environment, a barometric pressure of the environment, a temperature of the rear glass, a temperature of an internal cabin of the vehicle and a sun load on the vehicle; (ii) comparing, using the controller and/or the remote service, the one or more factors to one or more corresponding predetermined thresholds or ranges that are indicative of conditions suitable for frost formation on the rear glass; (iii) detecting a commanded start of the vehicle; and (iv) if the comparison indicates that the one or more factors meet the frost formation conditions and a commanded start of the vehicle is detected, then activating the rear glass defroster.

In this embodiment, the detecting step may be performed before the determining, comparing and activating steps. Also, if a commanded start is detected, then the method may proceed to the determining, comparing and activating steps.

The method may further include establishing a location of the vehicle. Additionally, at least one of location-related information, factor-related information and comparison-related information may be communicated between the vehicle and the remote service. The method may also include setting a flag in a memory associated with the controller (if the comparison indicates that the one or more factors meet the frost formation conditions), and if the flag is set and a commanded start of the vehicle is detected, then activating the rear glass defroster. And in any of the foregoing cases, the remote service and the vehicle may communicate with each other via one or more of a cellular signal, a satellite signal, a Wi-Fi signal, a Bluetooth signal, a radio signal and an interne signal.

According to yet another embodiment, a rear-glass defrost system for a vehicle includes a rear glass, a rear glass defroster for defrosting the rear glass, one or more sensors, and a controller operatively connected with the defroster and the one or more sensors. In this embodiment, the one or more sensors are configured to sense one or more factors selected from a temperature of an environment immediately outside the vehicle, a humidity of the environment, a dew point of the environment, a barometric pressure of the environment, a temperature of the rear glass, a temperature of an internal cabin of the vehicle and a sun load on the vehicle. Additionally, the controller is configured to determine the one or more factors using the one or more sensors and/or a remote service that is in communication with the vehicle, compare the one or more factors to one or more corresponding predetermined thresholds or ranges that are indicative of conditions suitable for frost formation on a rear glass of the vehicle, and if the comparison indicates that the one or more factors meet the frost formation conditions, then activate the rear glass defroster.

In this rear-glass defrost system, the controller may be further configured to detect a commanded start of the vehicle, and if the comparison indicates that the one or more factors meet the frost formation conditions and a commanded start of the vehicle is detected, then activate the rear glass defroster. Additionally or alternatively, the controller may be further configured to establish a location of the vehicle using the remote service.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

FIG. 1 is a schematic top view of a vehicle having a rear glass defrost system according to the present disclosure.

FIG. 2 is a block diagram of a rear glass defrost system according to the present disclosure.

FIG. 3 is a flowchart for a method according to the present disclosure.

FIG. 4 is a flowchart for another method according to the present disclosure.

### DETAILED DESCRIPTION

Referring now to the drawings, wherein like numerals indicate like parts in the several views, a rear glass defroster 28 and rear glass defroster system 36 for a vehicle 20, and multiple embodiments of a method 100, 200 for controlling the defroster 28 or defroster system 36, are shown and described herein. The rear glass defroster 28, rear glass defroster system 36 and methods 100, 200 presented are particularly suited for electric vehicles because of the need to manage the battery budget in such vehicles, but these are also suitable for hybrid vehicles and conventional internal combustion engine vehicles as well.

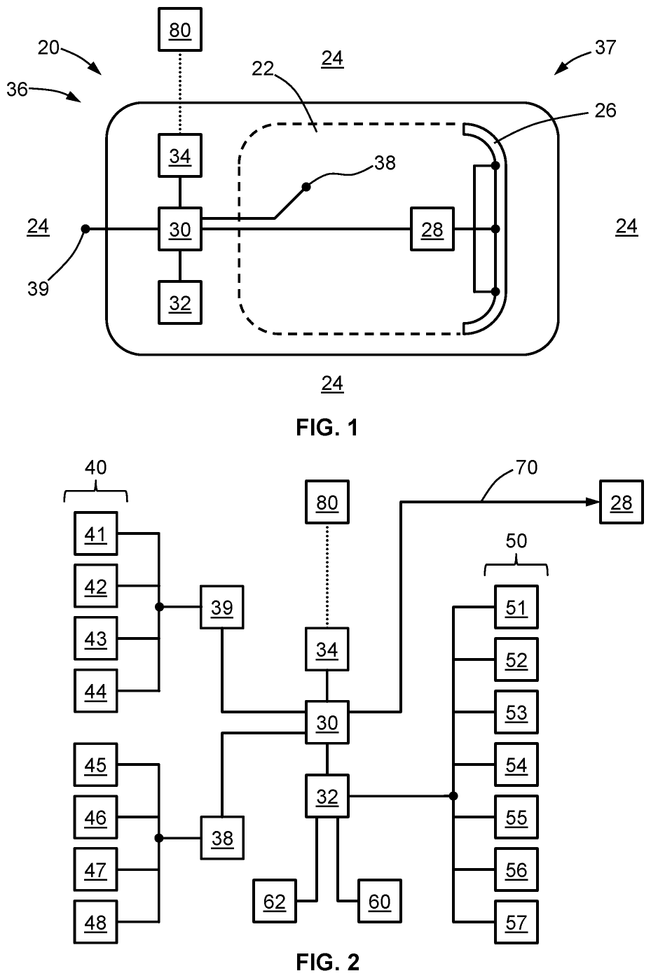

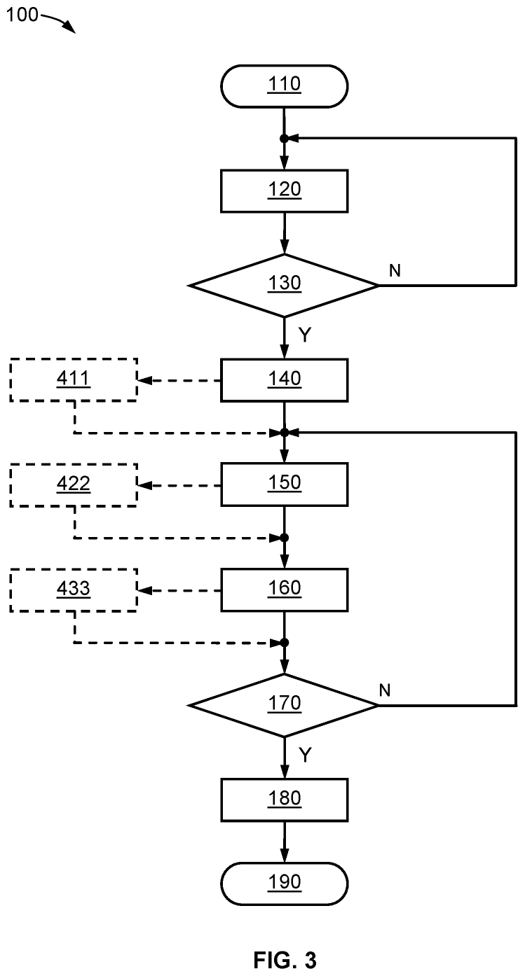

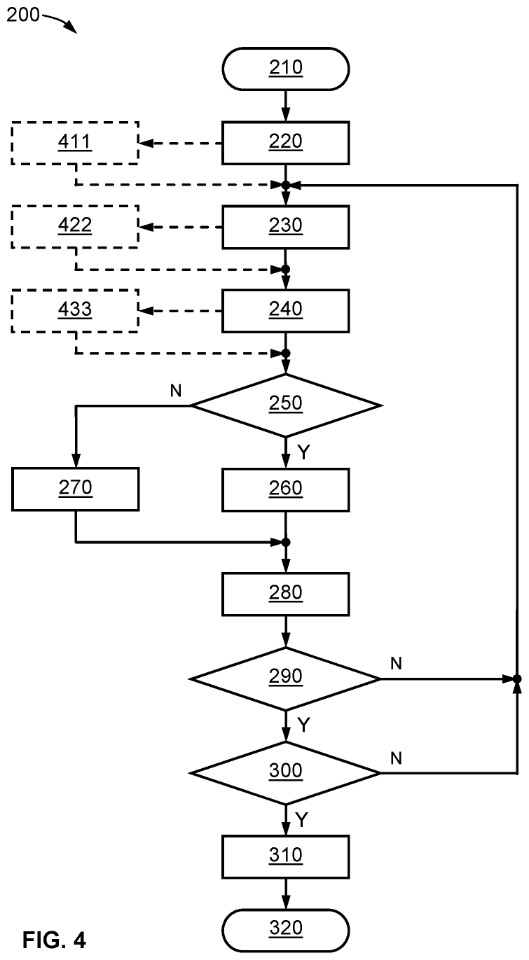

FIG. 1 shows a schematic top view of a vehicle 20 having a rear glass defroster 28 and rear glass defrost system 36, while FIG. 2 shows a block diagram of the rear glass defrost system 36 with its various components and interconnections. Relatedly, FIGS. 3-4 show flowcharts for first and second methods 100, 200, respectively, for controlling the rear glass defroster 28 and defroster system 36.

Referring now to FIG. 1, the vehicle 20 is shown having an interior cabin or passenger compartment 22 and an exterior environment 24 immediately outside of and surrounding the vehicle 20. In this view, the forward direction is toward the left of the drawing and the rearward direction is toward the right of the drawing. A rear glass 26 forms a rearward portion of the interior cabin 22, with one surface of the glass 26 pointing inward and forward and the opposing surface of the glass 26 pointing outward and rearward.

A defroster 28 is operatively connected with or directed toward the rear glass 26. The defroster 28 may be a blower which blows heated air onto the inward/forward surface of the rear glass 26, or it may be an electrical device which includes a series of resistive wires or elements embedded on or within the rear glass 26. In either case, the defroster 28 requires electrical power to operate, which is drawn from an electrical source such as the vehicle's battery (not shown). The defroster 28 is also operatively connected with a controller 30 which controls the activation (i.e., electrical powering) of the defroster 28. The controller 30 is shown in FIG. 1 as being inside the vehicle 20 but outside of the interior cabin 22 (such as in the vehicle's engine bay), but this is for illustration purposes only, as the controller 30 may also be disposed within the interior cabin 22.

The controller 30 is also operatively connected with a memory 32 and a transceiver 34. The memory 32 and the transceiver 34 may be physically separate elements from the controller 30, as shown in the drawings, or they may be part of the controller 30 itself. The memory 32 is configured for storing data and/or instructions therein, such as predetermined parameters or settings (e.g., stored in a lookup table) and executable computer code. The transceiver 34 may be a transmitter and/or a receiver configured to send and/or receive data wirelessly, such as by one or more of a cellular signal, a satellite signal, a Wi-Fi signal, a Bluetooth signal, a radio signal and an internet signal.

The transceiver 34 may be in communication with a remote service 80, such as a back-end service for monitoring and communicating data back-and-forth with the vehicle 20. That is, the transceiver 34 may send data to the remote service 80 and receive data from the remote service 80, and the remote service 80 may receive data from the transceiver 34 and send data to the transceiver 34. Although the drawings illustrate the remote service 80 as being a single element at a single location, the remote service 80 may also include multiple elements at multiple locations (e.g., multiple cell towers, multiple satellites, multiple computers/server sites, etc.), and these multiple elements and multiple locations may serve as a remote service network.

The controller 30 is also operatively connected with one or more sensors 38, 39. These may include interior sensors 38 located within the vehicle 20 (such as inside the interior cabin 22) and exterior sensors 39 located outside the vehicle 20 (such as on the outer skin or body of the vehicle 20).

As illustrated by the block diagram of FIG. 2, the one or more sensors 38, 39 may be configured to sense one or more factors 40. These factors 40 may be external environmental factors or conditions outside of the vehicle 20 (such as the temperature 41, humidity 42, dew point 43 and barometric pressure 44 of the external environment 24), or they may be internal environmental factors or conditions inside the vehicle 20 or interior cabin 22 (such as the temperature 45 of the rear glass 26 and the temperature 46 of the internal cabin 22), or they may be operational factors or conditions of the vehicle 20 (such as whether the vehicle 20 is in a commanded start 48 condition). The factors 40 may also include a sun load 47 on the vehicle 20, which may be sensed by a light intensity sensor mounted on the inside of the vehicle 20 (such as on the top of the dashboard, thus making the sensor an internal/interior sensor 38), or it may be mounted on the outside of the vehicle 20 (such as on the roof or within the front grille or cowling of the vehicle 20, thus making the sensor an external/exterior sensor 39). Additional factors 40 may be considered as well, such as the presence of external wind, the average external wind speed, the wind speed as measured over a period of time, etc.

As noted above, the controller 30 may include and/or may be operatively connected with a memory 32 and a transceiver 34. The memory 32 may include one or more predetermined thresholds or ranges 50 which are associated with the aforementioned factors 40. (As used herein, a “threshold” refers to one or more discrete values associated with a particular factor 40, while a “range” refers to a continuous range of values. For example, for the external temperature factor 41, an associated predetermined threshold 51 might be 32 degrees Fahrenheit (0 degrees Celsius), which is the freezing/melting point of water, and/or an associated predetermined range 51 might be any temperature at or below 32 degrees Fahrenheit.) These predetermined thresholds/ranges 50 may include one or more of the following: (i) a predetermined exterior temperature threshold/range 51, (i) a predetermined exterior humidity threshold/range 52, (iii) a predetermined exterior dew point threshold/range 53, (iv) a predetermined exterior barometric pressure threshold/range 54, (v) a predetermined rear glass temperature threshold/range 55, (vi) a predetermined interior cabin temperature threshold/range 56, and (vii) a predetermined sun load threshold/range 57. These one or more predetermined thresholds or ranges 50 may be stored in the memory 32, such as in a lookup table, or they may be stored within the controller 30 itself.

In addition to (or instead of) the one or more predetermined thresholds/ranges 50, the memory 32 (or controller 30) may additionally (or alternatively) include a frost conditions map 60. This map 60 is a collection of all the situations or sets of conditions in which the various factors 40 may act to produce frost or ice on the rear glass 26. The map 60 may include situations or sets of conditions based on one factor 40 (e.g., external temperature 41), two factors 40 (e.g., external temperature 41 and rear glass temperature 45, or external temperature 41 and sun load 47), and even three or more factors 40. For example, one situation or set of conditions (based on one factor 40) may be when the external temperature 41 is at or below a predetermined external temperature threshold 51 of 32 degrees Fahrenheit. Another situation or set of conditions (based on one factor 40) may be when the rear glass temperature 45 is at or below a predetermined rear glass temperature threshold 55 (e.g., 34 degrees Fahrenheit). Another situation or set of conditions (based on two factors 40) may be when the external temperature 41 is at or below a predetermined external temperature threshold 51 of 32 degrees Fahrenheit and the internal cabin temperature 46 is at or below a predetermined internal cabin temperature threshold 56. Additional situations or sets of conditions (based on one or more factors 40) may be used to formulate the frost conditions map 60 as well.

Thus, the controller 30 may receive inputs from the one or more sensors 38, 39 which are indicative of the one or more factors 40, and compare these factors 40 to the one or more predetermined thresholds/ranges 50 and/or to the frost conditions map 60, and thereby determine whether it is likely that frost may form on the rear glass 26. If the conditions are such that the formation of frost is determined to be likely, then the controller 30 may take action to activate (i.e., send electrical power to) the defroster 28, so that the rear glass 26 may be heated so as to melt any frost which may have formed or may be forming on the rear glass 26, and/or to prevent any potential frost from forming on the rear glass 26.

As an example of how the rear glass defrost system 36 may operate, the transceiver 34 (as prompted by the controller 30) may transmit a signal indicating the location 37 of the vehicle 20 along with a vehicle identifier, and the remote service 80 may receive this signal and utilize the location to determine the current weather conditions for that location, or the recent, current and upcoming weather conditions over some time period. The remote service 80 may then broadcast these weather conditions, along with the vehicle identifier, and the vehicle 20 may receive this signal through its transceiver 34, which sends the signal to the vehicle's controller 30. If the broadcasted vehicle identifier matches that of the vehicle 20, then the vehicle's controller 30 can confirm that the broadcasted weather conditions were meant for this particular vehicle 20 (and not for some other vehicle).

Alternatively, rather than the vehicle's transceiver 34 transmitting a signal indicating the location 37 and vehicle identifier of the vehicle 20, the transmission may instead be a request for the vehicle location 37 (along with the vehicle identifier). In this case, the remote service 80 may receive this signal from the vehicle 20, and may utilize GPS (global positioning satellites), cell tower locations, triangulation and the like to determine the exact location 37 of the vehicle 20. The remote service 80 may then broadcast the vehicle location 37 along with the vehicle identifier, and this signal may be received by the vehicle's transceiver 34, which sends the signal to the vehicle's controller 30. If the broadcasted vehicle identifier matches that of the vehicle 20, then the vehicle's controller 30 can confirm that the broadcasted vehicle location 37 was meant for this particular vehicle 20 (and not for some other vehicle). Optionally, the signal broadcasted by the remote service 80 may also include the weather conditions for the determined vehicle location 37.

As another alternative, the vehicle 20 may determine its location 37 not by broadcasting a request signal, but instead may determine its location 37 simply by receiving one or more GPS signals which are constantly being broadcasted from orbiting satellites.

As a further alternative, rather than the vehicle 20 receiving weather condition information from the remote service 80, the vehicle 20 may instead determine the local weather conditions of its external environment 24 by utilizing external sensors 39 associated with the vehicle 20.

Once the vehicle's controller 30 has the appropriate information regarding the weather conditions of the vehicle's external environment 24, the conditions of the interior cabin 22 and the operational conditions of the vehicle 20, the controller 30 may compare these factors 40 against the frost conditions map 60 and/or against the predetermined thresholds and ranges 50 to determine whether frost conditions exist or are imminent. If actual or potential frost conditions are found, then the controller 30 may send an activation signal 70 to the defroster 28. This activation signal 70 may be a power signal (e.g., a certain voltage and/or current) or it may be a control signal which causes power to be directed to the defroster 28. Optionally, the controller 30 may set a flag 62 in the memory 32 (or within the controller 30 itself) to indicate that the frost conditions have been met. For example, a particular register in the memory 32 may be set to an initial or default value of “0” to indicate that frost conditions are not met, and the register may be set to a value of “1” to indicate that frost conditions have been met. As used herein, when a flag 62 is referred to as being “set”, it is meant that the relevant register or address in the memory 32 or controller 30 has been purposefully and intentionally set to a value that is indicative of the frost formation conditions being met.

FIGS. 3-4 show flowcharts for two different but related embodiments of a method 100, 200 for controlling a defroster 28 or defroster system 36. Turning first to FIG. 3, a first embodiment or method 100 is shown, with the process flow beginning at block 110 and ending at block 190. For example, block 110 may represent when the vehicle 20 and the vehicle's controller 30 are powered up, and block 190 may represent when activation of the defroster 28 has been completed. According to this embodiment, the method 100 for controlling a rear glass defroster 28 or defroster system 36 for a vehicle 20 upon start-up includes: (i) at block 150, determining one or more factors 40 selected from among a temperature 41 of an environment 24 immediately outside the vehicle 20, a humidity 42 of the environment 24, a dew point 43 of the environment 24, a barometric pressure 44 of the environment 24, a temperature 45 of the rear glass 26, a temperature 46 of the internal cabin 22 and a sun load 47 on the vehicle 20; (ii) at block 160, comparing the one or more factors 40 to one or more corresponding predetermined thresholds or ranges 50 (and/or to the frost conditions map 60) which are indicative of conditions suitable for frost formation on the rear glass 26 of the vehicle 20; and (iii) at block 170, deciding or determining if the comparison of block 160 indicates that the one or more factors 40 meet the frost formation conditions, and if it does, then, at block 180, activating the rear glass defroster 28. However, if the comparison indicates that the factors 40 do not meet the frost formation conditions, then the process flow may be directed back to block 150.

The method 100 may further include, at block 120, detecting or sensing for a commanded start 48 of the vehicle 20. (This may include detecting or sensing for a commanded start event, or for a commanded start state or condition. For example, if a user presses the “START” button on a vehicle's key fob, this will transmit a momentary start command, which may be considered as a commanded start event, and once the vehicle 20 is started, it may be considered as being in a commanded start state or condition.) This detecting step of block 120 may be performed before the determining, comparing and activating steps of blocks 150, 160 and 170. The method 100 may further include, at block 130, determining whether a commanded start 48 has been detected; if a commanded start 48 is detected, then the process flow may be directed on to the determining, comparing and activating steps of blocks 150, 160 and 170, but if no commanded start 48 is detected, then the process flow may be directed back to block 120, whereupon the controller 30 and/or sensors 38, 39 may continue to detect or sense for a commanded start 48.

Additionally, the method 100 may further include, at block 140, establishing a location 37 of the vehicle 20. One or more of the establishing, determining and comparing steps of blocks 140, 150 and 160 may be performed by a remote service 80 that is in communication with the vehicle 20, with location-related information, factor-related information and/or comparison-related information, respectively, being communicated between the vehicle 20 and the remote service 80. The remote service 80 and the vehicle 20 may communicate with each other via one or more of a cellular signal, a satellite signal, a Wi-Fi signal, a Bluetooth signal, a radio signal and an internet signal. Alternatively, one or more of the establishing, determining and comparing steps of blocks 140, 150 and 160 may be performed by the controller 30 on-board the vehicle 20.

Turning now to FIG. 4, a second embodiment or method 200 is shown for controlling a rear glass defroster system 36 for a vehicle 20 upon start-up, with the process flow beginning at block 210 and ending at block 320. For example, block 210 may represent when the vehicle's controller 30 is powered up, and block 320 may represent when activation of the defroster 28 has been completed. In this embodiment, the defroster system 36 includes a rear glass 26, a rear glass defroster 28, one or more sensors 38, 39, and a controller 30 operatively connected with the defroster 28 and the one or more sensors 38, 39. This second embodiment or method 200 includes: (i) at block 230, determining, using the one or more sensors 38, 39 and/or a remote service 80 that is in communication with the vehicle 20, one or more factors 40 selected from a temperature 41 of an environment 24 immediately outside the vehicle 20, a humidity 42 of the environment 24, a dew point 43 of the environment 24, a barometric pressure 44 of the environment 24, a temperature 45 of the rear glass 26, a temperature 46 of an internal cabin 22 of the vehicle 20 and a sun load 47 on the vehicle 20; (ii) at block 240, comparing, using the controller 30 and/or the remote service 80, the one or more factors 40 to one or more corresponding predetermined thresholds or ranges 50 that are indicative of conditions suitable for frost formation on the rear glass 26; (iii) at block 280, detecting a commanded start 48 of the vehicle 20; and (iv) at block 250, if the comparison of block 240 indicates that the one or more factors 40 meet the frost formation conditions, and at block 290, if a commanded start 48 of the vehicle 20 is detected, then, at block 310, the rear glass defroster 28 is activated.

(It may be noted that the foregoing sequence of steps also applies to FIG. 3 as well. For example, the first embodiment or method 100 may include: (i) at block 150, determining, using the one or more sensors 38, 39 and/or a remote service 80 that is in communication with the vehicle 20, one or more factors 40 selected from a temperature 41 of an environment 24 immediately outside the vehicle 20, a humidity 42 of the environment 24, a dew point 43 of the environment 24, a barometric pressure 44 of the environment 24, a temperature 45 of the rear glass 26, a temperature 46 of an internal cabin 22 of the vehicle 20 and a sun load 47 on the vehicle 20; (ii) at block 160, comparing, using the controller 30 and/or the remote service 80, the one or more factors 40 to one or more corresponding predetermined thresholds or ranges 50 that are indicative of conditions suitable for frost formation on the rear glass 26; (iii) at block 120, detecting a commanded start 48 of the vehicle 20; and (iv) at block 170, if the comparison of block 160 indicates that the one or more factors 40 meet the frost formation conditions, and at block 130, if a commanded start 48 of the vehicle 20 is detected, then, at block 180, the rear glass defroster 28 is activated.)

Note that the step of detecting a commanded start 48 appears in the first embodiment or method 100 of FIG. 3 as block 120, while it appears in the second embodiment or method 200 of FIG. 4 as block 280. As illustrated by the drawings, the step of detecting a commanded start 48 may appear at the beginning of the process flow as shown in FIG. 3, or it may appear toward the end of the process flow as shown in FIG. 4. In the first method 100, the start-detecting step of block 120 is performed before the determining, comparing and activating steps of blocks 150, 160 and 180. Here in the first method 100, if a commanded start 48 is detected, then the decision step of block 130 allows the process flow to proceed on to the determining, comparing and activating steps of blocks 150, 160 and 180, but if a commanded start 48 is not detected, then the process flow routes back to block 120. In contrast, in the second method 200, the start-detecting step of block 280 is performed after the determining and comparing steps of blocks 230 and 240 (but before the activating step of block 310). Here in the second method 200, if a commanded start 48 is detected, then the decision step of block 290 allows the process flow to proceed on to block 300 (discussed below), but if a commanded start 48 is not detected, then the process flow routes back to block 230.

The second method 200 may further include, at block 220, the step of establishing a location 37 of the vehicle 20. At block 250, if the comparison of block 240 indicates that the one or more factors 40 meet the frost formation conditions, then the process flow is directed on to block 260, which is a step of setting a flag 62 in a memory 32 associated with the controller 30. (Here, the set flag 62 or “set” value is indicative of the frost formation conditions being met.) Otherwise, if the comparison of block 240 does not indicate that the factors 40 meet the frost formation conditions, then the process flow is routed to block 270, which is a step of assuring that the flag 62 or designated memory register is put to its default or “non-set” value (e.g., 0), as opposed to the designated “set” value (e.g., 1).

As noted above, at block 280 a detection is made of whether a start command 48 has been made. At the decision point of block 290, if no start command 48 has been detected, then the process flow is redirected back to block 230, but if a start command 48 has been detected, then the process flow continues on to block 300. At block 300, it is determined whether the flag 62 has been set; if it has not been set, then the process flow is directed back to block 230, but if it has been set, then the process flow continues on to block 310, which activates the rear glass defroster 28. Thus, in the second method 200 of FIG. 4, the rear glass defroster 28 is only activated if two conditions are met, namely: (i) the flag 62 is set (indicating that the frost formation conditions are met), and (ii) a commanded start 48 of the vehicle 20 is detected.

In any of the foregoing cases, the remote service 80 and the vehicle 20 may communicate with each other via one or more of a cellular signal, a satellite signal, a Wi-Fi signal, a Bluetooth signal, a radio signal and an internet signal. The information or data communicated between the vehicle 20 and the remote service 80 may be location-related information, factor-related information and/or comparison-related information.

Note that blocks 411, 422 and 433 in FIGS. 3-4 are shown in dashed lines. This is done to indicate that these blocks represent optional steps. Block 411 represents a step of communicating location-related information between the controller 30 and the remote service 80, block 422 represents a step of communicating factor-related information between the controller 30 and the remote service 80, block 433 represents a step of communicating comparison-related information between the controller 30 and the remote service 80. These communications may include use of the transceiver 34 to send and receive information to and from the remote service 80, as well as use of the memory 32 to store and provide such information. Note that if the controller 30 does not receive any of the abovementioned information from the remote service 80, the controller 30 may receive the information from the one or more sensors 38, 39 and/or the controller 30 may generate or derive such information by itself. For example, the controller 30 may utilize the sensors 38, 39 to determine the factors 40 rather than receiving factor-related information from the remote service 80. Also, the controller 30 may perform the comparison between the factors 40 and the predetermined thresholds/ranges 50 and/or the frost conditions map 60, rather than receiving comparison-related information (e.g., the results of the comparison) from the remote service 80.

With regard to the first and second methods 100, 200 illustrated in FIGS. 3-4, it may be noted that the determining steps of blocks 150 and 230 may be performed by using the one or more sensors 38, 39 and/or by using the remote service 80, as well as by using the controller 30 in conjunction with the sensors 38, 39 and/or the remote service 80. Additionally, the comparing steps of blocks 160 and 240 may be performed using the controller 30 and/or by using the remote service 80. (For example, the controller 30 may perform the comparison, or the remote service 80 may perform the comparison, or both the controller 30 and the remote service 80 may work together to collectively perform the comparison.) Similarly, the deciding or determining steps of blocks 170 and 250 may be performed using the controller 30 and/or the remote service 80. Further, the activating steps of blocks 180 and 310 may be performed by the controller 30. The detecting or sensing steps of blocks 120 and 280 may be performed by an internal sensor 38, such as an electrical continuity sensor placed in-line with the vehicle's “START” button or ignition, in conjunction with the controller 30. Alternatively, the detecting or sensing steps of blocks 120 and 280 may be performed by an internal or external sensor 38, 39, in conjunction with the controller 30, which detects a remote start command sent by the user in the form of a radio signal from the vehicle's key fob or in the form of a cellular or other signal from a phone app, or which detects a start command being received by the vehicle's start controller. The decision steps represented by blocks 130, 290 and 300 may be performed by the controller 30 and/or by the remote service 80. The location-establishing steps of blocks 140 and 220 may be performed by the controller 30 and/or by the remote service 80. And the flag-related steps of blocks 260 and 270 may be performed by the controller 30.

According to yet another embodiment, a rear glass defrost system 36 for a vehicle 20 includes a rear glass 26, a rear glass defroster 28 for defrosting the rear glass 26, one or more sensors 38, 39, and a controller 30 operatively connected with the defroster 28 and the one or more sensors 38, 39. In this embodiment, the one or more sensors 38, 39 are configured to sense one or more factors 40 selected from a temperature 41 of an environment 24 immediately outside the vehicle 20, a humidity 42 of the environment 24, a dew point 43 of the environment 24, a barometric pressure 44 of the environment 24, a temperature 45 of the rear glass 26, a temperature 46 of an internal cabin 22 of the vehicle 20 and a sun load 47 on the vehicle 20. Additionally, the controller 30 is configured to determine the one or more factors 40 using the one or more sensors 38, 39 and/or a remote service 80 that is in communication with the vehicle 20, compare the one or more factors 40 to one or more corresponding predetermined thresholds or ranges 50 that are indicative of conditions suitable for frost formation on a rear glass 26 of the vehicle 20, and if the comparison indicates that the one or more factors 40 meet the frost formation conditions, then activate the rear glass defroster 28.

In this rear glass defrost system 36, the controller 30 may be further configured to detect a commanded start 48 of the vehicle 20, and if the comparison indicates that the one or more factors 40 meet the frost formation conditions and a commanded start 48 of the vehicle 20 is detected, then the rear glass defroster 28 may be activated. Additionally or alternatively, the controller 30 may be further configured to establish a location 37 of the vehicle 20 using the remote service 80.

It may be noted that since much the description of the system 36 and methods 100, 200 herein have focused on unspecified “vehicles” 20, the claims and description may be broadly interpreted as applying to all types of vehicles 20, such as conventional internal combustion engine vehicles, hybrid/partially electric vehicles and fully electric vehicles. However, if it is determined during the prosecution of the present application that the claims should be limited to only hybrid/partially electric vehicles and/or to fully electric vehicles, then some of the claims herein may be amended so as to replace the word “vehicle” with the phrase “electric vehicle”.

The above description is intended to be illustrative, and not restrictive. While the dimensions and types of materials described herein are intended to be illustrative, they are by no means limiting and are exemplary embodiments. In the following claims, use of the terms “first”, “second”, “top”, “bottom”, etc. are used merely as labels, and are not intended to impose numerical or positional requirements on their objects. As used herein, an element or step recited in the singular and preceded by the word “a” or “an” should be understood as not excluding plural of such elements or steps, unless such exclusion is explicitly stated. Additionally, the phrase “at least one of A and B” and the phrase “A and/or B” should each be understood to mean “only A, only B, or both A and B”. Moreover, unless explicitly stated to the contrary, embodiments “comprising” or “having” an element or a plurality of elements having a particular property may include additional such elements not having that property. And when broadly descriptive adverbs such as “substantially” and “generally” are used herein to modify an adjective, these adverbs mean “mostly”, “mainly”, “for the most part”, “to a significant extent”, “to a large degree” and/or “at least 51 to 99% out of a possible extent of 100%”, and do not necessarily mean “perfectly”, “completely”, “strictly”, “entirely” or “100%”. Additionally, the word “proximate” may be used herein to describe the location of an object or portion thereof with respect to another object or portion thereof, and/or to describe the positional relationship of two objects or their respective portions thereof with respect to each other, and may mean “near”, “adjacent”, “close to”, “close by”, “at” or the like.

The flowcharts and block diagrams in the drawings illustrate the architecture, functionality and/or operation of possible implementations of systems, methods and computer program products according to various embodiments of the present disclosure. In this regard, each block in the flowchart or block diagrams may represent a module, segment or portion of code, which includes one or more executable instructions for implementing the specified logical function(s). It will also be noted that each block of the block diagrams and/or flowchart illustrations, and combinations of blocks in the block diagrams and/or flowchart illustrations, may be implemented by hardware-based systems that perform the specified functions or acts, or combinations of hardware and computer instructions. These computer program instructions may also be stored in a computer-readable medium that can direct a controller or other programmable data processing apparatus to function in a particular manner, such that the instructions stored in the computer-readable medium produce an article of manufacture including instructions to implement the functions and/or actions specified in the flowcharts and block diagrams.

This written description uses examples, including the best mode, to enable those skilled in the art to make and use devices, systems and compositions of matter, and to perform methods, according to this disclosure. It is the following claims, including equivalents, which define the scope of the present disclosure.

What is claimed is:

1. A method for controlling a rear glass defroster for a vehicle upon start-up, comprising:
determining one or more factors selected from a temperature of an environment immediately outside the vehicle, a humidity of the environment, a dew point of the environment, a barometric pressure of the environment, a temperature of a rear glass of the vehicle, a temperature of an internal cabin of the vehicle and a sun load on the vehicle;
comparing the one or more factors to one or more corresponding predetermined thresholds or ranges that are indicative of conditions suitable for frost formation on a rear glass of the vehicle; and
if the comparison indicates that the one or more factors meet the frost formation conditions, then activating the rear glass defroster.

2. The method of claim 1, further comprising:
detecting a commanded start of the vehicle.

3. The method of claim 2, wherein the detecting step is performed before the determining, comparing and activating steps.

4. The method of claim 3, wherein if the commanded start is detected, then proceeding to the determining, comparing and activating steps.

5. The method of claim 1, further comprising:
establishing a location of the vehicle.

6. The method of claim 5, wherein at least one of the establishing, determining and comparing steps is performed by a remote service that is in communication with the vehicle.

7. The method of claim 5, wherein at least one of location-related information, factor-related information and comparison-related information is communicated between the vehicle and the remote service.

8. The method of claim 5, wherein at least one of the establishing, determining and comparing steps is performed by a controller on-board the vehicle.

9. The method of claim 1, further comprising:
if the comparison indicates that the one or more factors meet the frost formation conditions, then setting a flag in a memory;
detecting a commanded start of the vehicle; and
if the flag is set and a commanded start of the vehicle is detected, then activating the rear glass defroster.

10. The method of claim 6, wherein the remote service and the vehicle communicate with each other via one or more of a cellular signal, a satellite signal, a Wi-Fi signal, a Bluetooth signal, a radio signal and an internet signal.

11. A method for controlling a rear glass defroster system for a vehicle upon start-up, wherein the system includes a rear glass, a rear glass defroster, one or more sensors, and a controller operatively connected with the defroster and the one or more sensors, the method comprising:
determining, using the one or more sensors and/or a remote service that is in communication with the vehicle, one or more factors selected from a temperature of an environment immediately outside the vehicle, a humidity of the environment, a dew point of the environment, a barometric pressure of the environment, a temperature of the rear glass, a temperature of an internal cabin of the vehicle and a sun load on the vehicle;
comparing, using the controller and/or the remote service, the one or more factors to one or more corresponding predetermined thresholds or ranges that are indicative of conditions suitable for frost formation on the rear glass;
detecting a commanded start of the vehicle; and
if the comparison indicates that the one or more factors meet the frost formation conditions and a commanded start of the vehicle is detected, then activating the rear glass defroster.

12. The method of claim 11, wherein the detecting step is performed before the determining, comparing and activating steps.

13. The method of claim 12, wherein if the commanded start is detected, then proceeding to the determining, comparing and activating steps.

14. The method of claim 11, further comprising:
establishing a location of the vehicle.

15. The method of claim 14, wherein at least one of location-related information, factor-related information and comparison-related information is communicated between the vehicle and the remote service.

16. The method of claim 11, further comprising:
if the comparison indicates that the one or more factors meet the frost formation conditions, then setting a flag in a memory associated with the controller; and
if the flag is set and a commanded start of the vehicle is detected, then activating the rear glass defroster.

17. The method of claim 11, wherein the remote service and the vehicle communicate with each other via one or more of a cellular signal, a satellite signal, a Wi-Fi signal, a Bluetooth signal, a radio signal and an internet signal.

18. A rear-glass defrost system for a vehicle, comprising:
a rear glass;
a rear glass defroster for defrosting the rear glass;
one or more sensors configured to sense one or more factors selected from a temperature of an environment immediately outside the vehicle, a humidity of the environment, a dew point of the environment, a barometric pressure of the environment, a temperature of the rear glass, a temperature of an internal cabin of the vehicle and a sun load on the vehicle; and
a controller operatively connected with the defroster and the one or more sensors, the controller being configured to:
determine the one or more factors using the one or more sensors and/or a remote service that is in communication with the vehicle;
compare the one or more factors to one or more corresponding predetermined thresholds or ranges that are indicative of conditions suitable for frost formation on a rear glass of the vehicle; and
if the comparison indicates that the one or more factors meet the frost formation conditions, then activate the rear glass defroster.

19. The rear-glass defrost system of claim 18, wherein the controller is further configured to:
detect a commanded start of the vehicle; and
if the comparison indicates that the one or more factors meet the frost formation conditions and a commanded start of the vehicle is detected, then activate the rear glass defroster.

20. The rear-glass defrost system of claim 18, wherein the controller is further configured to:
establish a location of the vehicle using the remote service.
